(19) United States
(12) Patent Application Publication
(10) Pub. No.: US 2003/0031273 A1
(43) Pub. Date: Feb. 13, 2003

(54) Quadrature gain and phase imbalance correction in a receiver

(76) Inventor: Rishi Mohindra, Milpitas, CA (US)

Correspondence Address: Brian R Coleman, Patent Attorney, Perkins Coie LLP, P.O. Box 2168, Melon Park, CA, 95026-2168, US

(21) Appl. No.: 09/927,762

(22) Filed: Aug. 10, 2001

(51) Int. Cl. H04L 27/14

(52) U.S. Cl. 375/324; 327/238

(57) ABSTRACT

The present invention offers a low cost, reliable, on chip implementation that takes advantage of circuitry already present in receivers to produce a calibration tone used in quadrature signal imbalance adjustments. The present invention employs multiple phase shifters and a double sideband suppressed carrier to produce calibration signals.

### CROSS REFERENCE TO RELATED APPLICATIONS

None

### STATEMENT REGARDING FEDERALLY SPONSORED RESEARCH

None

### BACKGROUND OF THE INVENTION

The invention relates to a method for correcting the gain and phase imbalance in quadrature paths of a receiver.

Conversion of the communication signal into the form suitable for transmission upon the radio frequency (RF) channel is effectuated by a process referred to as modulation. In such a process, the communication signal is impressed upon an RF carrier signal. The resultant signal is commonly referred to as a modulated carrier signal. The transmitter includes circuitry operative to perform such a modulation process.

The receiver of the radio communication contains circuitry analogous to, but operative in a manner reverse with that of, the circuitry of the transmitter. The receiver is operative to perform a process referred to as demodulation.

In radio communication systems, specific modulation schemes are employed to minimize the frequency spectrum necessary for communication and thereby maximize the call capacity of the radio communication system. The modulation schemes utilized usually involve converting the communication signal into discrete form, and the resultant modulated signal is typically of a reduced frequency spectrum.

One method of transmitting a communication signal in discrete form is through the use of quadrature modulation. In quadrature modulation, the binary data stream of the encoded communication signal is separated into bit pairs. Such bit pairs are utilized to cause phase shifts of the RF carrier signal in increments such as plus or minus .pi./4 radians or plus or minus 3.pi./4 radians, according to the values of the individual bit pairs of the encoded signal.

The phase shifts are effectuated by applying the binary data stream comprised of the bit pairs to a pair of mixer circuits. A sine component of a carrier signal is applied to an input of a first mixer circuit, and a cosine component of a carrier signal is applied to an input of a second mixer circuit. The sine and cosine components of the carrier signal are in a relative phase relationship of ninety degrees with one another, or phase quadrature. A quadrature generator is utilized to generate and apply the sine and cosine components of the carrier signal to the first and second mixer circuits of the pair of mixer circuits, respectively.

In many radio communication systems, a heterodyne architecture is used for the transmitter and receiver in order to reduce the susceptibility to interfering signals that may be present. In a heterodyne architecture, frequency conversion to an intermediate frequency (IF) is first performed to obtain the filter selectivity needed to reject interfering signals. Conversion to an IF aids in the selectivity process and allows the selectivity to be achieved with physically realizable filters. A drawback to the heterodyne architecture is that the conversion to an IF requires extra circuit complexity, more power consumption, and more physical space. The filters used are usually ceramic filters or surface acoustic wave (SAW) filters, which are both expensive and physically large.

When phase or gain imbalance distorts the received signal, subsequent signal processing is impacted. The prior art has long used higher tolerance components in an attempt to avoid phase and/or amplitude imbalance between the I and Q components. Such an approach has significant cost impact and may still not adequately address the problem. Another prior art approach attempts to account for imbalance by estimating and removing such imbalance. One such approach is described in U.S. Pat. No. 5,396,656 issued on Mar. 7, 1995, to Jasper et al., for a Method For Determining Desired Components Of Quadrature Modulated Signals. Here, a closed loop feedback technique is used to continuously determine an error signal by updating estimates of an imbalance component until the magnitude of the error signal is negligible. This is shown in FIG. 1. Yet another approach is described in U.S. Pat. No. 4,122,448 issued on Oct. 24, 1978, to Martin, for an Automatic Phase And Gain Balance Controller For A Baseband Processor. Martin uses a pilot signal to obtain phase and amplitude imbalances, and these imbalances are corrected using a feedback circuit.

Thus, conventional circuits therefore rely on using a modulated or unmodulated signal to perform quadrature imbalance correction. These signals may be generated locally or received. Commonly the locally generated tone is produced by a Phase Locked Loop (PLL) and a Voltage Controlled Oscillator (VCO), or a non-local signal is received using single-sideband modulator. A separate PLL and VCO are too costly to provide additionally, while a single side-band modulator needs to be calibrated precisely before being inserted into the circuit. Therefore a solution is required that takes into account all the above mentioned problems and limitations associated with quadrature imbalance correction circuits.

### SUMMARY OF THE INVENTION

The present invention generates a receiver calibration signal by mixing a low frequency signal with the local oscillator within the receiver to produce a double sideband suppressed carrier signal. The advantage of this method is that a separate tone or signal is not needed for the calibration process. Further, additional PLL and VCO circuits are also unnecessary. The present invention therefore overcomes the drawbacks of the conventional quadrature calibration circuits.

Therefore the present invention offers a low cost, reliable, on chip implementation that takes advantage of circuitry already present to detect and correct for quadrature phase imbalances.

### BRIEF DESCRIPTION OF THE DRAWINGS

FIG. 1 shows a prior art quadrature imbalance circuit.

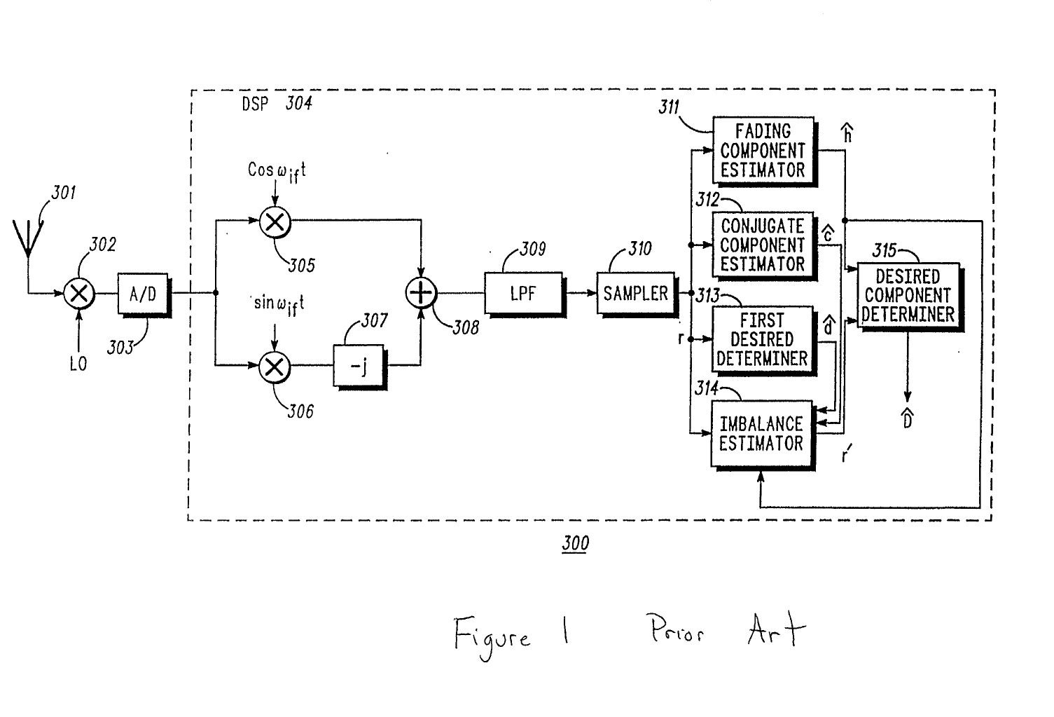

FIG. 2 shows the circuit of the present invention.

FIG. 3 shows the phase shifter P2 as shown in FIG. 2.

### DETAILED DESCRIPTION OF THE INVENTION

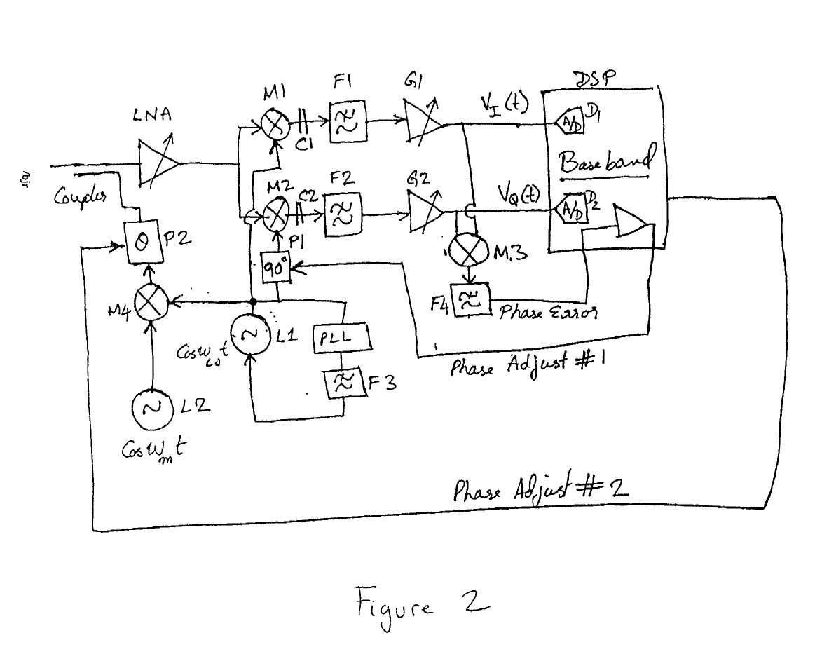

Referring to FIG. 2 the preferred embodiment of the present invention is shown. This schematic shows the detection and correction of the quadrature phases, commonly referred to as the I and Q (In phase and Quadrature phase) signals. LNA1 is a standard low noise amplifier commonly used to amplify low power high frequency RF signals. The incoming radio signal into LNA1 comes from an antennae A1. The received signal will be broken into quadrature components by using mixing circuits M1 and M2 and phase adjusting circuit P1. The outputs of M1 and M2 will become the baseband signals. For example, if the incoming signal has a bandwidth of 20 MHz, each of the I and Q branches will be signals of 10 MHz bandwidth. As is conventional in quadrature circuits, capacitors C1 and C2 are used to block any dc component of signal and filters F1 and F2 are used to further filter unwanted signals. Before any quadrature modulation is performed however, it is critical that the receiver be properly calibrated.

In order to produce a reliable calibration tone, the local oscillator L1 is mixed with a low frequency tone produced by L2. An example of these frequencies would be L1 set at 5 Gigahertz, while L2 is set at 5 Megahertz. The local oscillator L1 is also used with a Phase Locked Loop PLL1 and a filter F3. These two signals would be multiplied by a mixing circuit M4. The resulting multiplication of two sine waves of differing frequencies results in two signals being produced, wherein the resulting sine wave are at different frequencies. For example cos (A)×cos (B)=cos (A+B)+cos (A−B). Therefore the mixer M4 produces two signals for the calibration process. As mentioned previously, prior art methods do not employ circuitry nor signals of this type for the calibration signal generators. Standard prior art methods employ only one tone for calibration purposes whereas the instant invention uses two. In this example the frequencies are 5 GHz+5 MHz and 5 GHz−5 MHz. It is noted that this Double Side-Band Suppressed Carrier signal (DSBSC) may be coupled in the receiver's RF path at either the LNA input or the LNA output.

The two calibration tones will be fed into Mixers M1 and M2 for quadrature processing. Using two tones for calibration however, would pose a problem for prior art circuits. In this scenario the In-phase branch would be a clear signal but the Quadrature phase would be zero. In order to overcome this problem a Phase Shifter P2 is implemented. The phase shifter P2 adds an angle theta to the frequency of a calibration tone signal. For example when P2 is set to zero, VI is cos (wt) and VQ is zero. When P2 is set to 90 degrees, the VI signal is nonexistent while VQ is cos (wt).

The calibration process using Phase Shifter P2 would then be as follows. P2 is adjusted so as to obtain the maximum value of signal in the VI branch. The adjustment of P2 is performed by the Digital Signal Processing chip C1. This maximum signal level is measured by baseband processor chip C1 and stored. Then P2 is adjusted by 90 degrees until the signal in the Q branch is at a maximum level. This maximum level of the Q branch is also measured and stored in the baseband processor chip C1. Once these maximum values of each branch are known, the baseband processor chip may perform a gain imbalance calibration. This gain imbalance correction may be performed by amplifiers G1 and G2 or after analogue to digital signal conversion (A/D) in the baseband processor chip C1. It is noted that G1 and G2 may perform the gain adjustments for the receiver as a whole. It is also noted that G1 and G2 are controlled together as opposed to separately. The I and Q gains are therefore made equal to avoid any sideband production and distortion of the desired signal. The present invention also allows for gain imbalance calibration to be performed at any level of gain as set by G1 and G2.

With respect to the phase adjustment, P2 would be set at a value such as 45 degrees. This ensures a signal in both the I and the Q branch of almost equal value. By simply multiplying the two signals together one can detect the relative phase of the I and Q branches. The product of a sine and cosine signal should result in zero. Mixer circuit M3 accomplishes the multiplication of the I and Q signals and outputs this signal to a filter F4. If this is not the case, meaning that the I and Q branches are not exactly 90 degrees out of phase as desired, a phase error signal is produced. This signal is fed back through an error amplifier and filter EF to Phase Shifter P1 which will compensate for the error. Ideally the phase difference between the I and Q braches should be 90 degrees. Therefore, the adjustment of P2 with the appropriate gain control in addition with the adjustment of P1, allow for an optimum phase imbalance to be performed. It is noted that P1 may be in the RF path instead of being in the local oscillator path if desired.

In a second embodiment, the phase shifter P2 may be used in another manner than the one described above. In this embodiment, the phase shifter is constantly varying the angle of shift. For example, theta starts at zero and constantly increases. While the amount of phase shift varies, the in-phase and quadrature signals will vary in amplitude. At some values of theta both signals are present, while other values of theta result in only one of the two signals being present. As in the previous embodiment, the peak amplitudes of each of the in-phase and quadrature signals are measured by the chip C1. This allows another way to detect the maximum amplitudes needed for gain compensation.

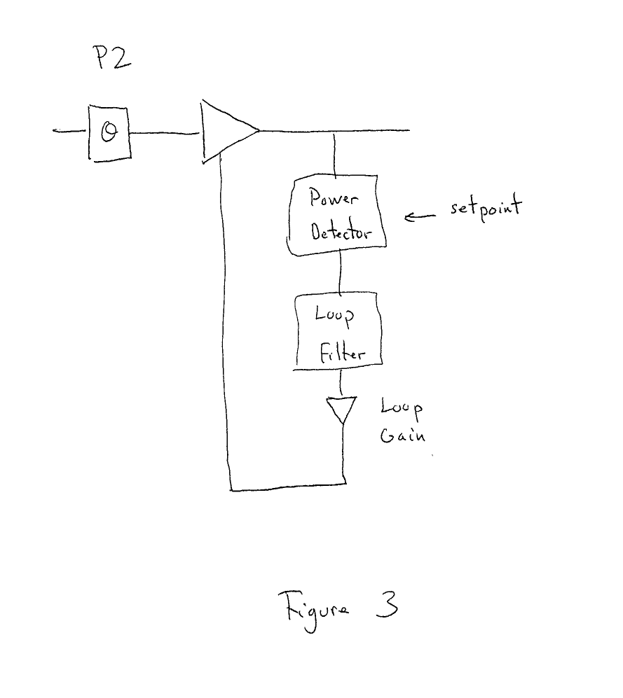

FIG. 3 of the present invention shows one embodiment of how the Phase Shifter P2 may be implemented. Given that the amplitudes of the signals involved in the calibration process are critical, it is important that P2 does not modify the signal strength of the signal that it is shifting. Therefore it must be ensured that P2 will not provide gain or loss to the signal for any range of shift in degrees. In the present invention the output of P2 is a constant amplitude independent of the phase shift. A limiter or automatic gain control device would be used to ensure this constant output voltage level. FIG. 3 shows the use of a power detector that determines the power of the calibration signal. This detected power is compared to a set point value. If the signal is somewhat off the desired set point level, an error signal may be generated to compensate for this fact. This type of feedback allows P2 to output a constant voltage as desired.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method for correcting imbalance between in-phase and quadrature components of a received signal comprising the steps of:
adjusting a first phase angle to determining a peak amplitude for the in-phase component of the received signal;
adjusting a first phase angle to determining a peak amplitude for the quadrature component of the received signal;
adjusting a first phase angle to set the amplitudes for the in-phase and quadrature components of the received signal to be approximately equal; and
adjusting a second phase angle so that the inphase and quadrature components of the received signal are 90 degrees out of phase.

2. The method of claim 1, further comprising the step of mixing a low frequency signal with a local oscillator signal.

3. The method of claim 2, wherein a double sideband suppressed carrier signal is produced for correcting imbalance between in-phase and quadrature components of the received signal.

4. The method of claim 3, further comprising the step using the determined peak amplitudes to scale the gains of the in-phase and quadrature components to be equal.

5. A communication device for correcting imbalance between in-phase and quadrature components of a received signal comprising:
a low frequency oscillator that produces a low frequency signal;
a high frequency oscillator that produces a high frequency signal;
a first mixer to multiply the signals produced by the low and high frequency oscillators that produces a double side-band suppressed carrier signal;
a second and third mixer to produce in-phase and quadrature components of the received signal from the double side-band suppressed carrier signal;
a first phase shifter circuit to adjust the phase of the double side band suppressed carrier input radio frequency calibration signal to determine the peak amplitudes of the in-phase and quadrature components of the received signal;
a gain scaling circuit to set the relative amplitudes of the in-phase and quadrature components of the received signal to be substantially equal;
a fourth mixer circuit to multiply the in-phase and quadrature components to produce a relative phase error signal; and
a second phase shifter circuit to adjust the relative phase between the in-phase and quadrature components of the received signal to be 90 degrees, by adjusting the relative phase difference between the high frequency oscillator inputs to the second and third mixers.

6. The communication device of claim 5, wherein the first phase shifter comprises a power detector circuit.

7. The communication device of claim 6, wherein the power detector compares the power in a signal to a desired level of power.

8. The communication device of claim 7, wherein the first phase shifter further comprises a loop filter.

9. The communication device of claim 8, wherein the first phase shifter further comprises an amplifier such that the voltage output from the first phase shifter is constant and independent of the amount of phase shift.

10. The communication device of claim 9, further comprising a phase locked loop circuit and a filter circuit connected to the high frequency oscillator.

11. A method for correcting imbalance between in-phase and quadrature components of a received signal comprising the steps of:
producing a low frequency signal;
producing a high frequency signal;
multiplying the low and high frequency signals to produce a double side-band suppressed carrier signal;
producing in-phase and quadrature components of the received signal from the double side-band suppressed carrier signal;
shifting the phase of the double side band suppressed carrier signal to determine the peak amplitudes of the in-phase and quadrature components of the received signal;
scaling the gain to set the relative amplitudes of the in-phase and quadrature components of the received signal to be substantially equal;
multiplying the in-phase and quadrature components to produce a relative phase error signal; and
shifting the relative phase between the in-phase and quadrature components of the received signal to be 90 degrees.

12. The method of claim 11, further comprising the step of detecting the power of phase shifter of the double side band suppressed carrier signal

13. The method of claim 12, further comprising the step of comparing the detected power to a desired level of power.

14. The method of claim 13, further comprising the step of providing a constant output voltage while shifting the relative phase of the the double side band suppressed carrier signal.

15. The method of claim 14, further comprising the step of coupling the double side band suppressed carrier signal to a receiver's RF path at a low noise amplifier input.

16. A radio receiver comprising:
an antenna;
a quadrature receiver for receiving signals and converting the received signals into inphase baseband and a quadrature baseband signals;
a digital signal processor for performing the following tasks:
determining an imbalance in the quadrature receiver between the inphase and quadrature signals of the test signal under varying conditions,
generating a correction factor for at least some of the varying conditions, and
applying one or more correction factors to subsequently received inphase and quadrature baseband signals depending on a current condition to minimize an imbalance between the subsequently received inphase and quadrature baseband signals.

17. The radio receiver in claim 16, wherein one of the varying conditions is a changing gain of the baseband signals.

18. The radio receiver in claim 17, wherein one of the varying conditions is changing the phase relationship between the baseband signals.

19. The method of claim 3, further comprising the step of coupling the double side band suppressed carrier signal to a receiver's RF path at a low noise amplifier input terminal.

20. The communication device of claim 5 further comprising a means to couple the double side band suppressed carrier signal to the communication devices' RF path at a low noise amplifier input terminal.
